(19) United States
(12) Patent Application Publication
(10) Pub. No.: US 2015/0247468 A1
(43) Pub. Date: Sep. 3, 2015

(54) METHOD TO OPERATE A DUAL-NOZZLE FUEL INJECTOR

(71) Applicant: Caterpillar Inc., Peoria, IL (US)

(72) Inventor: Jonathan R. Chittenden, Edwards, IL (US)

(73) Assignee: Caterpillar Inc., Peoria, IL (US)

(21) Appl. No.: 14/700,212

(22) Filed: Apr. 30, 2015

(51) Int. Cl. F02D 19/02; F02M 61/10; F02M 51/06

(52) U.S. Cl. CPC F02D 19/024; F02M 51/061; F02M 61/10

(57) ABSTRACT

A method to operate a dual-nozzle fuel injector is provided. The dual-nozzle fuel injector includes a first control valve, a second control valve, a first control chamber, a second control chamber, a drain, a first needle check, a second needle check, a first nozzle outlet, a second nozzle outlet, and a dual solenoid actuator. The dual solenoid actuator selectively actuates the first control valve and the second control valve to connect the first control chamber and the second control chamber, respectively, to the drain. Flow of a liquid fuel from the first control chamber and the second control chamber, respectively, lifts the first needle check and the second needle check. The first needle check lifts to deliver a first pre-determined amount of the liquid fuel into the cylinder. The second needle check lifts to deliver a second pre-determined amount of the liquid fuel into the cylinder.

### TECHNICAL FIELD

The present disclosure relates to a fuel system where a liquid fuel is injected into a combustion chamber of an engine. More particularly, the present disclosure relates to a control of a dual-nozzle fuel injector via pressure of a liquid fuel.

### BACKGROUND

There is an increasing demand for engines to be able to run on both diesel and gaseous fuels (such as natural gas, methane, propane, and the like). To provide maximum flexibility to the customer, it may be desirable for the engine to be operable on a range of fuel from 100 percent diesel fuel to nearly 100 percent gaseous fuel, based on the ever-changing availability and cost of the fuels. Conventionally, gaseous fuel engines may use a spark plug to ignite an air-fuel mixture. However, traditional diesel engines lack the spark plug. One way to operate the engine on the gaseous fuel without use of the spark plug, is to use a diesel fuel injector to inject a small amount of diesel fuel to initiate combustion of a gaseous air-fuel mixture. This may present a challenge for the diesel fuel injector because the size of a nozzle and a check valve required to deliver the injection shot sizes needed for 100 percent diesel mode may not be well suited to deliver the small injection shot sizes needed for 100 percent gaseous fuel mode. The gaseous fuel may be injected in the engine in numerous ways, such as single point injection, multi-point injection, or direct injection. Since there is a large difference in the injection shot sizes for the 100 percent diesel fuel mode and the 100 percent gaseous fuel mode, a single nozzle fuel injector may not optimized to deliver the needed quantities of the fuel to a combustion chamber of the engine. Thus it would be desirable to provide a fuel injector capable of effectively delivering fuel over a broader range of shot sizes than is possible with a single nozzle.

### SUMMARY OF THE INVENTION

Various aspects of the present disclosure describe a method to operate a dual-nozzle fuel injector of a cylinder. The dual-nozzle fuel injector includes a first control valve, a second control valve, a first control chamber, a second control chamber, a drain, a first needle check, a second needle check, a first nozzle outlet, a second nozzle outlet, and a dual solenoid actuator. The dual solenoid actuator selectively actuates the first control valve to control the flow of a liquid fuel from the first control chamber to the drain. Similarly, the dual solenoid actuator selectively actuates the second control valve to control the flow of the liquid fuel from the second control chamber to the drain. The dual solenoid actuator sends at least one of a first injection signal and a second injection signal to the first control valve and the second control valve, respectively. The first control valve is actuated based on receipt of the first injection signal. Actuation of the first control valve connects the first control chamber to the drain, which causes the first needle check to open the first nozzle outlet. A first pre-determined amount of the liquid fuel is delivered via the first nozzle outlet. The first nozzle outlet is configured to deliver a lesser quantity of the liquid fuel compared to a delivery of the liquid fuel by the second nozzle outlet. Similarly, the second control valve is actuated based on receipt of the second injection signal. Actuation of the second control valve connects the second control chamber to the drain. This causes the second needle check to open the second nozzle outlet and deliver a second pre-determined amount of the liquid fuel in the cylinder for combustion.

### BRIEF DESCRIPTION OF THE DRAWINGS

FIG. 1 is a diagrammatic view of an engine system, in accordance with the concepts of the present disclosure;

FIG. 2 is a sectional side view of a dual-nozzle fuel injector of the engine system of FIG. 1, in accordance with the concepts of the present disclosure; and

FIG. 3 illustrates a flowchart for a method to operate the dual-nozzle fuel injector of FIG. 2, in accordance with the concepts of the present disclosure.

### DETAILED DESCRIPTION

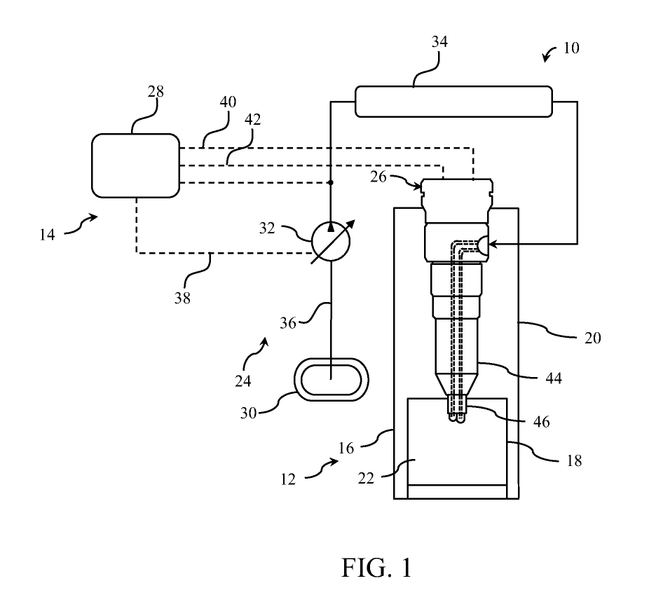

Referring to FIG. 1, there is shown an engine system 10. The engine system 10 includes an engine 12 and a fuel system 14. The engine 12 includes a housing 16 with a cylinder 18. The cylinder 18 includes a cylinder head 20 and a combustion chamber 22. Although only one cylinder is shown, the engine 12 may typically include multiple such cylinders. The engine system 10 further includes the fuel system 14. The fuel system 14 includes a liquid fuel supply 24, a gaseous fuel supply (not shown), a dual-nozzle fuel injector 26, and an electronic control module 28.

The liquid fuel supply 24 includes a tank 30, a pressurizing mechanism 32, and a liquid fuel common rail 34. The tank 30 contains a liquid fuel, such as diesel fuel. The tank 30 is fluidly connected to the pressurizing mechanism 32, via a fluid line 36. The liquid fuel of the tank 30 is pressurized by the pressurizing mechanism 32, and delivered to the liquid fuel common rail 34. Similarly, the gaseous fuel supply (not shown) may also include a reservoir (not shown), to store a gaseous fuel, such as natural gas. The gaseous fuel may be delivered via direct injection, port injection, manifold injection (either single or multi point), throttle body injection, or the like.

The electronic control module 28 may be used to electronically control various parts of the fuel system 14, such as the pressurizing mechanism 32. The electronic control module 28, along with various sensors (not shown) and a communication line 38 is used to vary an output of the pressurizing mechanism 32, to control fuel pressures within the liquid fuel common rail 34. The electronic control module 28 is also connected to the dual-nozzle fuel injector 26, via communication lines 40 and 42.

The dual-nozzle fuel injector 26 is coupled with the housing 16 and is fitted into the cylinder head 20. The dual-nozzle fuel injector 26 will be herein after referred to as the fuel injector 26. The fuel injector 26 includes an injector body 44.

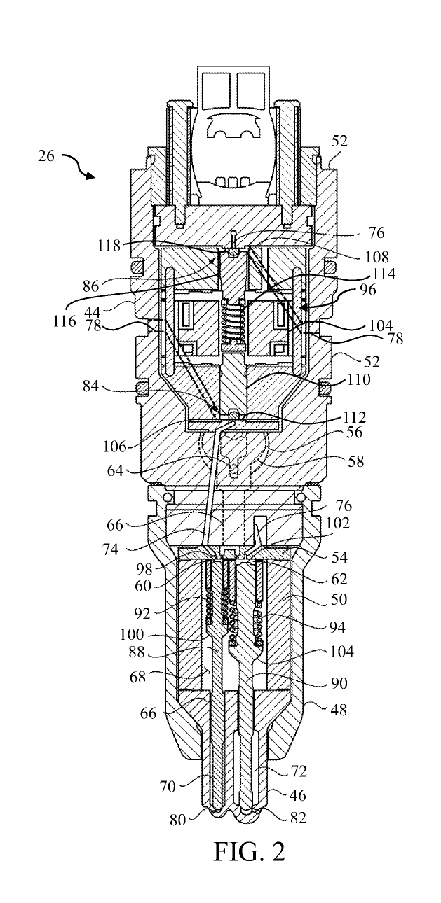

Referring to FIG. 2, the injector body 44 includes a tip piece 46, an outer body piece 48, an inner body piece 50, an upper body piece 52, and an orifice plate 54. The tip piece 46 is co-axially positioned within the outer body piece 48, which in turn is attached to the upper body piece 52. The tip piece 46 extends into the cylinder 18. The inner body piece 50 and the orifice plate 54 are clamped between the upper body piece 52 and the tip piece 46.

The injector body 44 further defines a first inlet 56, a second inlet 58, a first control chamber 60, a second control chamber 62, a first supply passage 64, a second supply passage 66, a chamber 68, a first cavity 70, a second cavity 72, a first drain passage 74, a second drain passage 76, a drain 78, a first nozzle outlet 80, and a second nozzle outlet 82. The first control chamber 60 and the second control chamber 62 are structured within the inner body piece 50 and are in fluid communication with the first inlet 56 and the second inlet 58, respectively. The first inlet 56 and the second inlet 58 further, supply the liquid fuel to the chamber 68, via the first supply passage 64 and the second supply passage 66. The chamber 68 is in fluid communication with the first cavity 70 and the second cavity 72, which are defined in the tip piece 46, and are of a smaller volume as compared to the chamber 68. The first cavity 70 has smaller volume as compared to the second cavity 72. The first cavity 70 and the second cavity 72 are selectively fluidly connected to the first nozzle outlet 80 and the second nozzle outlet 82, respectively. The first nozzle outlet 80 has a smaller dimensions as compared to the second nozzle outlet 82, such that larger amount of the liquid fuel is injected through the second nozzle outlet 82. The first nozzle outlet 80 is functional to inject the liquid fuel to initiate the gaseous fuel combustion event. The second nozzle outlet 82 may be functional to inject the liquid fuel during liquid fuel injection event. In addition, the first control chamber 60 and the second control chamber 62 are in fluid communication with the first drain passage 74 and the second drain passage 76. The first drain passage 74 fluidly connects the first control chamber 60 with the drain 78. The second drain passage 76 fluidly connects the second control chamber 62 to the drain 78.

The injector body 44 is structured to house a first control valve 84, a second control valve 86, a first needle check 88, a second needle check 90, a first spring 92, a second spring 94, and a dual solenoid actuator 96. The first needle check 88 is movable within the injector body 44, to open and close the first nozzle outlet 80. The first needle check 88 has a closing hydraulic surface 98, which is exposed to the fluid pressure of the first control chamber 60. The first needle check 88 further has an opening hydraulic surface 100, which is exposed to the fuel pressure of the first supply passage 64. In the FIG. 2 illustration, the first supply passage 64 is partially hidden from view. However, it will be understood by those skilled in the art that the passage extends through the components positioned between the first inlet 56 and the first nozzle outlet 80 to supply the liquid fuel for injection.

The second needle check 90 is positioned side-by-side, and typically parallel to the first needle check 88, and is movable within the injector body 44 to open and close the second nozzle outlet 82. The second needle check 90 includes a closing hydraulic surface 102, which is exposed to a fluid pressure of the second control chamber 62, and an opening hydraulic surface 104, which is exposed to the fuel pressure of the second supply passage 66. In a practical implementation strategy, the chamber 68 houses the first spring 92 and the second spring 94. The first spring 92 biases the first needle check 88 closed to seal the first nozzle outlet 80. Similarly, the second spring 94 biases the second needle check 90 closed to seal the second nozzle outlet 82. Lift of the first needle check 88 and the second needle check 90 may occur in opposition to a bias of the corresponding springs 92 and 94. It may be recalled, the opening hydraulic surfaces 100 and 104 may be exposed to the fuel pressure of the first supply passage 64 and the second supply passage 66, which is typically equal to the fuel pressure in the liquid fuel common rail 34. In the embodiment shown, the chamber 68 forms a segment of the first supply passage 64 and the second supply passage 66.

The dual solenoid actuator 96 is in control communication with the electronic control module 28. The electronic control module 28 generates a first injection signal and a second injection signal, which are received by the dual solenoid actuator 96. The dual solenoid actuator 96 is operable to actuate the first control valve 84 and the second control valve 86. The dual solenoid actuator 96 is shown in its non-injection configuration with a first armature 106 and a second armature 108. The first armature 106 and the second armature 108 are in an un-energized position. The first armature 106 is connected to a first pusher 110, which is configured to hold the first control valve 84 in an upward, closed position in contact with a first flat seat 112, under the action of a shared spring 114. The second armature 108 is connected to a second pusher 116, to urge the second control valve 86 into contact with a second flat seat 118 by the shared spring 114.

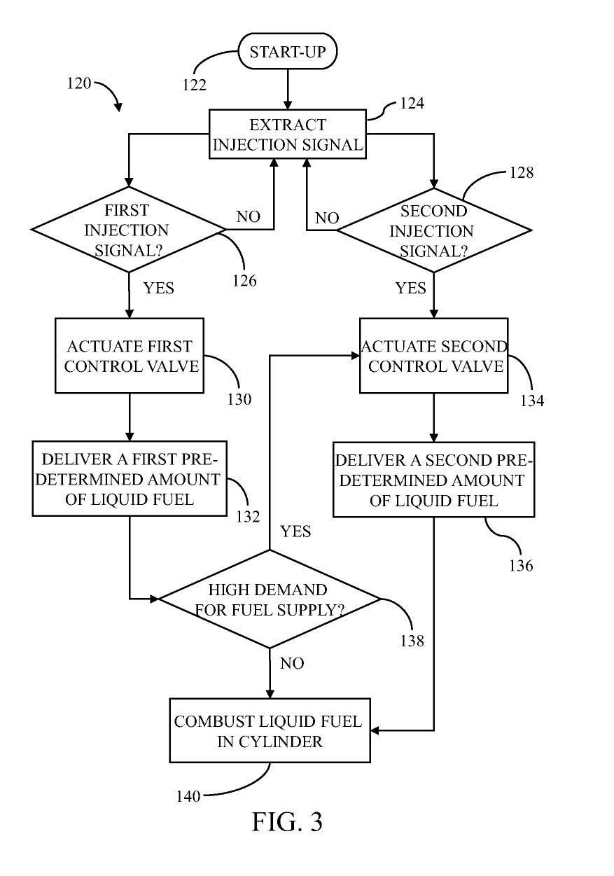

Referring to FIG. 3, there is shown a flowchart for a method 120 to operate the fuel injector 26. The method 120 begins at step 122, when the electronic control module 28 signals for an injection event.

At step 124, the electronic control module 28 generates an injection signal and sends the injection signal to the dual solenoid actuator 96. The method 120, simultaneously, proceeds to step 126 and step 128. In an embodiment of the disclosure, step 126 is selected for a gas mode of operation and the step 128 is selected for a liquid mode of operation.

At step 126, the dual solenoid actuator 96 identifies the received injection signal as the first injection signal. Upon determination that the injection signal is the first injection signal, the method 120 proceeds to step 130. Otherwise, the method 120 returns to step 124.

At step 128, the dual solenoid actuator 96 identifies the received injection signal as the second injection signal. Upon determination that the injection signal is the second injection signal, the method 120 proceeds to step 134. Otherwise, the method 120 returns to step 124.

At step 130, the dual solenoid actuator 96 actuates the first control valve 84, to connect the first control chamber 60 to the drain 78. The method 120 proceeds to step 132.

At step 132, the pressure in the first control chamber 60 drops to lift the first needle check 88. This results in injection of a first pre-determined amount of the liquid fuel in the cylinder 18. The method 120 proceeds to step 138.

At step 134, the dual solenoid actuator 96 actuates the second control valve 86 to connect the second control chamber 62 to the drain 78. The method 120 proceeds to step 136.

At step 136, the pressure in the second control chamber 62 drops to lift the second needle check 90. This results in injection of a second pre-determined amount of the liquid fuel in the cylinder 18. The method 120 proceeds to step 138.

At step 138, the electronic control module 28 determines whether there is high demand for the liquid fuel. Upon this requirement, the method 120 returns to step 134. When high demand for the liquid fuel subsides, the method 120 proceeds to end step 140.

At end step 140, the liquid fuel is combusted in the cylinder 18.

### INDUSTRIAL APPLICABILITY

In operation, the electronic control module 28 signals the liquid fuel to move from the liquid fuel common rail 34, through the first inlet 56, through the first supply passage 64 and into the fuel injector 26. Similarly, the liquid fuel moves from the liquid fuel common rail 34 through the second inlet 58, through the second supply passage 66 and into the outer body piece 48 of the fuel injector 26. The electronic control module 28 also controls injection of a gaseous fuel into the cylinder 18. In order to initiate a gaseous fuel combustion event, the electronic control module 28 sends the first injection signal to the dual solenoid actuator 96. The dual solenoid actuator 96 is changed to a first injection configuration, to pull the first armature 106 down towards an energized position until the movement of the first pusher 110 (and the first armature 106) is arrested by a stop (not shown). When this occurs, the first control valve 84 moves (that is, pushed off seat by high pressure) to an open position and out of contact with the first flat seat 112. This configuration fluidly connects the first control chamber 60 and the first drain passage 74 to the drain 78. When this occurs, the pressure that acts on the closing hydraulic surface 98 decreases and is overcome by the pressure that acts on the opening hydraulic surface 100. This causes the first needle check 88 to move upward to open the first nozzle outlet 80. Thus, the first pre-determined amount of the liquid fuel from the first cavity 70 is injected into the cylinder 18, as pilot injection that ignites the gaseous fuel already compressed and contained in the cylinder 18. When it is time to end the pilot injection, the shared spring 114 pushes the first control valve 84 back up into contact with the first flat seat 112. This blocks the first drain passage 74 and increases pressure on the closing hydraulic surface 98, which causes the first needle check 88 to move down to close the first nozzle outlet 80.

The electronic control module 28 sends the second injection signal for initiation of a liquid fuel injection event. The dual solenoid actuator 96 thus actuates the second armature 108 to from an un-energized position to an energized position. When this occurs, the second pusher 116 is moved upward to permit the second control valve 86 to move to an open position. This configuration causes the second pusher 116 to be out of contact with the second flat seat 118, due to pressure in the second drain passage 76. When this occurs, the second control chamber 62 and the second drain passage 76 become fluidly connected to the drain 78, which causes the pressure on the closing hydraulic surface 102 to drop. When this occurs, the pressure that acts on the opening hydraulic surface 104 causes the second needle check 90 to move upward to open the second nozzle outlet 82 to the second inlet 58. Thus, the second pre-determined amount of the liquid fuel from the second cavity 72 is injected into the cylinder 18. To halt the liquid fuel injection event, the shared spring 114 then acts on the second pusher 116, to move the second armature 108 back up towards the un-energized position. This moves the second control valve 86 back to its closed position in contact with the second flat seat 118 to close the fluid connection between the second control chamber 62 and the drain 78. When this occurs, pressure on the closing hydraulic surface 102 again rises to cause the second needle check 90 to move down to close the second nozzle outlet 82. In an embodiment, the electronic control module 28, based on demand from the engine 12, may simultaneously send out the first injection signal and the second injection signal.

The disclosed fuel injector 26 is equipped with two different sized nozzle outlets, operable independently, to provide sufficient fuel flow for liquid fuel mode and gaseous fuel mode. The first nozzle outlet 80 is sized to accurately and efficiently deliver small and the first pre-determined amount of the liquid fuel into the cylinder 18 for pilot injection to combust the gaseous fuel. The second nozzle outlet 82 is sized for full flow and supply of the second pre-determined amount of the liquid fuel into the cylinder 18. This method 120 allows for 100 percent liquid fuel mode of combustion. The disclosed fuel injector 26 also facilitates accurate liquid fuel delivery over a much wider range of shot sizes and fuel flow rates than is possible with a single nozzle fuel injector.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure.

What is claimed is:

1. A method for operating a dual-nozzle fuel injector of an cylinder, the dual-nozzle fuel injector including a first control valve, a second control valve, a first control chamber, a second control chamber, a drain, a first needle check, a second needle check, a first nozzle outlet, a second nozzle outlet, and a dual solenoid actuator, the dual solenoid actuator selectively controlling the first control valve and the second control valve, the first control valve controlling flow of a liquid fuel from the first control chamber to the drain, and the second control valve controlling flow of the liquid fuel from the second control chamber to the drain, the method comprising:
providing at least one of a first injection signal and a second injection signal to the dual solenoid actuator;
actuating the first control valve based on receipt of the first injection signal, wherein actuating the first control valve connects the first control chamber to the drain, thereby causing the first needle check to open the first nozzle outlet;
delivering a first pre-determined amount of the liquid fuel via the first nozzle outlet, the first nozzle outlet is configured to deliver a lesser quantity of the liquid fuel compared to a delivery of the liquid fuel by the second nozzle outlet, wherein the liquid fuel injected in the cylinder is combusted;
actuating the second control valve based on receipt of the second injection signal, wherein actuating the second control valve connects the second control chamber to the drain, thereby causing the second needle check to open the second nozzle outlet; and
delivering a second pre-determined amount of the liquid fuel via the second nozzle outlet, wherein the liquid fuel injected in the cylinder is combusted.
